(19) United States
(12) Patent Application Publication
(10) Pub. No.: US 2023/0182088 A1
(43) Pub. Date: Jun. 15, 2023

(54) METHOD FOR PREPARING HIGH-SELECTIVITY LITHIUM-MAGNESIUM SEPARATION MEMBRANE

(71) Applicant: Tianjin University, Tianjin (CN)

(72) Inventors: Song ZHAO, Tianjin (CN); Zhi WANG, Tianjin (CN); Tingyu LI, Tianjin (CN); Yu ZHANG, Tianjin (CN); Jixiao WANG, Tianjin (CN)

(73) Assignee: Tianjin University, Tianjin (CN)

(21) Appl. No.: 18/070,513

(22) Filed: Nov. 29, 2022

(30) Foreign Application Priority Data
Dec. 13, 2021 (CN) 202111513403.2

(51) Int. Cl. B01D 69/12; B01D 67/00; B01D 69/02; B01D 71/56

(52) U.S. Cl. CPC B01D 69/1251; B01D 67/0006; B01D 67/0095; B01D 69/02; B01D 71/56; B01D 2323/36; B01D 2323/40; B01D 2323/081; B01D 2323/216; B01D 2323/219; B01D 2323/2183; B01D 2323/21815; B01D 2325/20; B01D 2325/34

(57) ABSTRACT

A method for preparing a high-selectivity lithium-magnesium separation membrane includes: (1) preparing an aqueous phase mixture containing aqueous phase monomer, crown ethers or aza-macrocycles, acid acceptor, surfactant and water; (2) preparing an organic phase mixture containing organic phase monomer, and organic solvent that is incompatible with water; (3) contacting the supporting membrane with the aqueous phase mixture to obtain an aqueous phase monomer-adsorbed supporting membrane; (4) contacting the aqueous phase monomer-adsorbed supporting membrane with an organic phase mixture for an interfacial polymerization reaction; and (5) placing a nascent membrane obtained into a drying oven and heat-treating the membrane to obtain a lithium-magnesium separation membrane. The present method is simple in preparation process, mild in preparation conditions, easy to scale up, and easy to realize industrial production. The prepared high-selectivity lithium-magnesium separation membrane is large in permeation flux, high in lithium-magnesium selectivity and good in long-term operation stability.

### CROSS REFERENCE TO THE RELATED APPLICATIONS

This application is based upon and claims priority to Chinese Patent Application No. 202111513403.2, filed on Dec. 13, 2021, the entire contents of which are incorporated herein by reference.

### TECHNICAL FIELD

The present invention relates to the technical field of lithium-magnesium separation, and in particular to a method for preparing a high-selectivity lithium-magnesium separation membrane.

### BACKGROUND

Lithium mainly exists in salt lake brines, ores and seawater, and lithium in salt lake brines accounts for about 70% of recoverable lithium worldwide. However, the high content of interfering ions in salt lake brines poses a great challenge for lithium extraction, and especially the presence of Mg ions greatly increases the complexity of a lithium extraction process in salt lake brines because Mg²⁺ and Li⁺ have similar chemical properties and comparable ionic radii.

In recent years, researchers have developed efficient lithium-magnesium separation techniques to extract Li⁺ from salt lake brines with a high Mg²⁺ concentration. The main lithium-magnesium separation techniques mainly include an extraction method, a precipitation method, an electrochemical method, an adsorption method and a membrane separation method. More organic solvents will be used for lithium-magnesium separation in the extraction method. The efficiency of lithium-magnesium separation in the precipitation method is generally not high. Although the lithium-magnesium separation in the electrochemical method can effectively extract Li⁺ in high-Mg systems, both the equipment cost and the time cost are high. The key to lithium-magnesium separation in the adsorption method is a high-performance adsorbent, but the selectivity of the adsorbent is easily limited by desorption, desorption and recycling. In contrast, the membrane separation method is low in cost, simple and green in process, and high in operability, and investigations on the lithium-magnesium separation have received more and more attention.

As the hydrated ions of Mg²⁺ and Li⁺ have diameters of 0.86 nm and 0.76 nm, respectively, nanofiltration membranes are used for lithium-magnesium separation in the industry. A separation layer of a conventional nanofiltration membrane material is mainly formed by the polymerization of monomers containing acyl chloride groups and amine groups. However, owing to the strong reactivity of acyl chloride and amine groups, the formed polyamide (PA) composite membrane, a commercially available NF membrane, often exhibits low permeance and Li⁺/Mg²⁺ separation factor, mainly due to their dense selective layer and negatively charged surface, which is hard to be applied for lithium extraction from brines. Therefore, it is highly anticipated and desirable to develop a lithium-magnesium separation membrane with high permeance and selectivity..

### SUMMARY

The present invention is intended to provide a method for preparing a high-selectivity lithium-magnesium separation membrane to solve the problems of the conventional nanofiltration membrane material such as low permeance/selectivity for lithium-magnesium separation and difficulty in satisfying the demand for lithium extraction from brines.

In order to achieve the above-mentioned purpose, the present invention provides a method for preparing a high-selectivity lithium-magnesium separation membrane, including the following steps:
(1) the preparation of aqueous phase mixture containing aqueous phase monomer, crown ethers or aza-macrocycles, acid acceptor, surfactant and water;
(2) the preparation of organic phase mixture containing organic phase monomer, and organic solvent that is incompatible with water;
(3) contacting the supporting membrane with the aqueous phase mixture to adsorb for a certain time to obtain the aqueous phase monomer-adsorbed supporting membranes;
(4) contacting the aqueous phase monomer-adsorbed supporting membrane with an organic phase mixture for an interfacial polymerization reaction;
(5) placing the nascent membrane obtained in the above-mentioned steps into a drying oven and heat-treating the membrane to obtain a lithium-magnesium separation membrane.

The aqueous phase mixture in step (1) includes (by mass fraction) 0.1-1% of aqueous phase monomer, 0.1-1% of crown ethers or aza-macrocycles, 0.1-2% of acid acceptor, 0.1-2% of surfactant and a remaining amount of water. Preferably, the mass fraction of the aqueous phase monomer is 0.1-0.5%, the mass fraction of the crown ethers or aza-macrocycles is 0.1-0.5%.

The organic phase mixture in step (2) includes (by mass fraction) 0.05-2% of organic phase monomer and a remaining amount of organic solvent. Preferably, the mass fraction of the organic phase monomer is 0.1-0.5%.

Preferably, the aqueous phase monomer in step (1) is selected from molecules comprising of two or more primary amine or secondary amine groups. More preferably, the aqueous phase monomer is selected from one or more of polyethylene imine, ethylene imine polymer, polyether amine, piperazine and m-phenylenediamine. More preferably, the aqueous phase monomer is polyethylene imine with a molecular weight of 600-70,000 Da.

Preferably, the crown ethers or aza-macrocycles in step (1) are selected from one or more of 15-crown-5-ether, cyclohexane-15-crown-5, benzo-15-crown ether-5, 4′-acetylbenzo-15-crown-5-ether, 4′-aminobenzo-15-crown-5-ether, 4,13-diazo-18-crown-6-ether, 18-crown ether-6, 1-aza-18-crown-6-ether, 2-(hydroxymethyl)-18-crown-6-ether, 1,4,7,10-tetraazacyclododecane, 1,4,7-tri-boc-1,4,7,10-tetraazacyclododecane, 1,4,7,10,13,16-hexaazacyclooctadecane, 1,4,7,10-tetraazacyclotridecane, 1,5,9-triazacyclododecane, 1,4,8,12-tetraazacyclopentadecane, 1,4,8,11-tetraazacyclotetradecane, Tetraethyl 1,4,8,11-tetraazacyclotetradecane-1,4,8,11-tetraacetate, and 1,4,8,11-tetramethyl-1,4,8,11-tetraazacyclotetradecane. More preferably, the crown ethers are selected from 15-crown-5-ether and 4′-aminobenzo-15-crown-5-ether. The aza-macrocycles are selected from 1,4,7,10-tetraazacyclododecane and 1,4,8,12-Tetraazacyclopentadecane.

Preferably, the acid acceptor in step (1) is one or more of sodium hydroxide, sodium carbonate and sodium bicarbonate. More preferably, the acid acceptor is sodium carbonate and sodium bicarbonate.

Preferably, the surfactant in step (1) is one or more of sodium dodecyl benzene sulfonate, sodium dodecyl sulfate, Tween 20 and cetyl trimethyl ammonium bromide. More preferably, the surfactant is sodium dodecyl sulfate.

Preferably, the organic phase monomer in step (2) is selected from molecules comprising of two or more acyl chloride groups. More preferably, the organic phase monomer is selected from one or more of 1, 3, 5-benzenetricarbonyl trichloride, 2,4-mesitylenedisulfonyl dichloride, 5-amino-2,4,6-triiodoisophthaloyl dichloride, 1,2-benzenedisulfonyl dichloride, 1,3-benzenedisulfonyl chloride, 2,6-pyridinedicarbonyl chloride, p-phthaloyl chloride, and 2,4-mesitylenedisulfonyl dichloride, and more preferably 1, 3, 5-benzenetricarbonyl trichloride.

Preferably, the organic solvent in step (2) is selected from one of N-hexane, n-heptane, and cyclohexane, or the mixture of them.

Preferably, the membrane material of the supporting membrane in step (3) is a porous polymeric membrane with a molecular weight cut-off of 10 kDa-80 kDa. More preferably, the material of porous polymeric membrane is one of polysulfone, polyethersulfone, polypropylene, polyvinylidene fluoride, polyacrylonitrile, polyimide and polytetrafluoroethylene.

Preferably, in step (3), the contacting operation between the supporting membrane and the aqueous phase mixture is wetting or dipping, the contacting time is 1-10 min, and the temperature of the aqueous phase mixture is 15-40° C.

Preferably, in step (4), the contacting operation is wetting or dipping, the contacting time is 1-10 min, and the temperature of the organic phase mixture is 15-40° C.

Preferably, in step (5), the temperature of heat-treatment is 60-100° C., and the time is 1-20 min.

Mechanism of the present invention: the aqueous phase monomer and the organic phase monomer of the present invention can react to form a structurally stable polyamide active layer taking the crown ethers or aza-macrocycles as internal channels, which could effectively regulate the structure of the polyamide active layer and facilitate the permeation of lithium-ion and water molecules. The type and concentration of the aqueous phase monomer, crown ethers or aza-macrocycles, and the organic phase monomer are related to a degree of cross-linking of the formed polyamide active layer. The PH value of the aqueous phase mixture can be adjusted by adding an acid acceptor to facilitate the interfacial polymerization reaction between the aqueous phase monomer and organic phase monomer. The addition of surfactant allows the crown ethers or aza-macrocycles to exist in the aqueous phase mixture uniformly and stably.

Therefore, a method for preparing a high-selectivity lithium-magnesium separation membrane in the above structure is adopted in the present invention, which has at least one or some of the following beneficial effects:
(1) the high-selectivity lithium-magnesium separation membrane has a stable and solid separation layer, a high permeate flux, and a good long-term operational stability;
(2) the high-selectivity lithium-magnesium separation membrane with a high lithium-magnesium selectivity can be applied to lithium extraction from brines or lithium extraction from salt lakes; and
(3) the method for preparing a high-selectivity lithium-magnesium separation membrane is simple in process, mild in preparation conditions, wide in application, easy to scale up and promote, and easy to realize industrial production.

The technical solutions of the present invention will be described below in further detail by means of the accompanying drawings and embodiments.

### BRIEF DESCRIPTION OF THE DRAWINGS

FIG. 1 is an SEM image of the surface of the supporting membrane in example 1 of the present invention.

FIG. 2 is an SEM image of the surface of the high-selectivity lithium-magnesium separation membrane in example 1 of the present invention.

FIG. 3 is an SEM image of the cross section of the high-selectivity lithium-magnesium separation membrane in example 1 of the present invention.

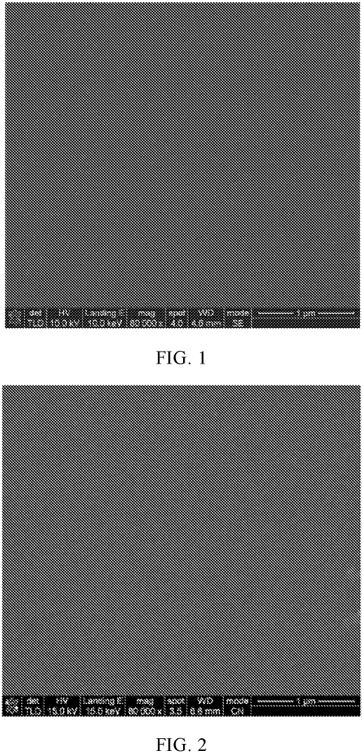

### DETAILED DESCRIPTION OF THE EMBODIMENTS

The present invention will be further described below. It should be noted that the present embodiment is predicated on the present technical solution and gives the detailed implementation mode and specific operation process, but the present invention is not limited to the present embodiment.

Materials used in the present invention: there is no special limitation to the source of all raw materials in the present invention and the following embodiments, and the raw materials are commercially available.

Method for testing the membrane flux of the high-selectivity lithium-magnesium separation membrane: a cross-flow filtration equipment was used to test membrane permeance, salt rejection, and selectivity. The test system includes a pump, a membrane cell, a pipeline, a regulating valve, and a pressure and flow detector, wherein the tested effective membrane area was 9.61 cm², the test pressure was 5 bar, and the test temperature was 25 ± 0.5° C. Concentrations of MgCl₂ and LiCl are both 500 ppm during the single-salt retention rate. A mixed salt concentration and a magnesium-lithium ratio for the lithium-magnesium separation performance were tested with total concentration of MgCl₂ and LiCl as 2,000 ppm and Mg²⁺/Li⁺=20.

The water permeance (L • m-^{2.}h^{-1.}bar⁻¹) was determined from Equation (1).

$$P e r m e a n c e = \frac{V}{A ⋅ Δ t ⋅ Δ P}$$

Where A (m²) refers to the valid membrane area, Δt (h) refers to the permeate time, ΔP (bar) refers to the trans-membrane pressure, V (L) refers to the permeate volume.

MgCl₂ or LiCl concentration in both sides was examined by the conductivity meter (DDSJ-308A, INASE Scientific Instrument Co., Ltd), while the salt rejection (%) was evaluated at pH 6.4. The rejection of Li⁺ or Mg²⁺ was examined by Equation (2).

$$R e j e c t i o n = \left(1 - \frac{{C}_{p e r m e a t e}}{{C}_{f e e d}}\right) \times 100 \%$$

Where Cₚₑᵣₘₑₐₜₑ (mg·L⁻¹) and C_{feed} (mg·L⁻¹) refer to the salt concentrations in permeate and feed solutions.

The separation factor (Li, Mg) was described the tendency of Li⁺ penetrating through the membrane relative to Mg²⁺, and calculated according to Equation (3). Inductively coupled plasma optical emission spectroscopy (ICP-OES; ICAP7000 Series, USA) was utilized to determine ion concentrations in mixed salt solutions.

$$S e p a r a t i o n f a c t o r = \frac{{C}_{L {i}^{+} , p} / {C}_{M {g}^{2 +} , p}}{{C}_{L {i}^{+} , f} / {C}_{M {g}^{2 +} , f}}$$

where C_{Li,p} and C_{Mg,p} are the concentrations of Li⁺ and Mg²⁺ in the permeate respectively (g/L); C_{Li,p} and C_{Mg,p} are the concentrations of Li⁺ and Mg²⁺ in the raw material solution respectively (g/L).

### Example 1

An aqueous solution containing 0.3% of polyethyleneimine (a molecular weight of 70,000 Da), 0.2% of 15-crown-5-ether, 0.1% of sodium carbonate and 0.1% of sodium dodecyl sulfate was prepared as an aqueous phase mixture. An n-hexane solution containing 0.1% of 1,3,5-benzenetricarboxylic acid chloride was prepared as an organic phase mixture. The aqueous phase mixture was placed on the surface of a polysulfone supporting membrane and adsorbed for 10 min, and excess solution was removed. Then the organic phase mixture was placed on the surface of the membrane, and reaction was kept for 1 min. Excess solution was removed, and unreacted monomers were rinsed off with n-hexane. Then the membrane was dried in a blast air oven at 80° C. for 10 min, and the prepared lithium-magnesium separation membrane was stored in deionized water for further testing of the separation property.

The lithium-magnesium separation membrane was tested to have a retention rate of ~25% for Li⁺, a retention rate of ~95% for Mg²⁺, a lithium-magnesium selectivity of ~18, and a water permeation flux of ~15 L • m⁻² • h⁻¹ • bar⁻¹.

### Example 2

An aqueous solution containing 0.5% of polyethyleneimine (a molecular weight of 10,000 Da), 0.3% of 4′-aminobenzo-15-crown-5-ether, 0.1% of sodium bicarbonate and 0.1% of sodium dodecyl sulfate was prepared as an aqueous phase mixture. An n-hexane solution containing 0.1% of 1,3,5-benzenetricarboxylic acid chloride was prepared as an organic phase mixture. The aqueous phase mixture was placed on the surface of a polyacrylonitrile supporting membrane and adsorbed for 5 min, and excess solution was removed. Then the organic phase mixture was placed on the surface of the membrane, and reaction was kept for 5 min. Excess solution was removed, and unreacted monomers were rinsed off with n-hexane. Then the membrane was dried in a blast air oven at 80° C. for 10 min, and the prepared lithium-magnesium separation membrane was stored in deionized water for further testing of the separation property.

The lithium-magnesium separation membrane was tested to have a retention rate of ~35% for Li⁺, a retention rate of ~95% for Mg²⁺, a lithium-magnesium selectivity of ~12, and a water permeation flux of ~8 L • m⁻² • h⁻¹ • bar⁻¹.

### Example 3

An aqueous solution containing 0.3% of polyetheramine (a molecular weight of 1800 Da), 0.5% of 4,13-diazo-18-crown-6-ether, 0.1% of sodium hydroxide and 0.1% of cetyl trimethyl ammonium bromide was prepared as an aqueous phase mixture. An n-hexane solution containing 0.2% of 1,3,5-benzene tricarbonic acid was prepared as an organic phase mixture. The aqueous phase mixture was placed on the surface of a polyether sulfone supporting membrane and adsorbed for 5 min, and excess solution was removed. Then the organic phase mixture was placed on the surface of the membrane, and reaction was kept for 10 min. Excess solution was removed, and unreacted monomers were rinsed off with n-hexane. Then the membrane was dried in a blast air oven at 80° C. for 10 min, and the prepared lithium-magnesium separation membrane was stored in deionized water for further testing of the separation property.

The lithium-magnesium separation membrane was tested to have a retention rate of ~20% for Li⁺, a retention rate of -91% for Mg²⁺, a lithium-magnesium selectivity of ~9, and a water permeation flux of ~13 L • m⁻² • h⁻¹ • bar⁻¹.

### Example 4

An aqueous solution containing 0.5% of polyetheramine (a molecular weight of 20,000 Da), 0.06% of 1,4,7,10-tetraazacyclododecane, 0.1% of sodium hydroxide and 0.1% of sodium dodecyl sulfate was prepared as an aqueous phase mixture. An n-hexane solution containing 0.1% of 1,3,5-benzene tricarbonic acid was prepared as an organic phase mixture. The aqueous phase mixture was placed on the surface of a polysulfone supporting membrane and adsorbed for 5 min, and excess solution was removed. Then the organic phase mixture was placed on the surface of the membrane, and reaction was kept for 10 min. Excess solution was removed, and unreacted monomers were rinsed off with n-hexane. Then the membrane was dried in a blast air oven at 80° C. for 10 min, and the prepared lithium-magnesium separation membrane was stored in deionized water for further testing of the separation property.

The lithium-magnesium separation membrane was tested to have a retention rate of ~24% for Li⁺, a retention rate of -91% for Mg²⁺, a lithium-magnesium selectivity of ~8, and a water permeation flux of ~12 L • m⁻² • h⁻¹ • bar⁻¹.

### Example 5

An aqueous solution containing 0.3% of polyetheramine (a molecular weight of 600 Da), 0.1% of 1,4,8,12-Tetraazacyclopentadecane, 0.1% of sodium hydroxide and 0.1% of cetyl trimethyl ammonium bromide was prepared as an aqueous phase mixture. An n-hexane solution containing 0.2% of 1,3,5-benzene tricarbonic acid was prepared as an organic phase mixture. The aqueous phase mixture was placed on the surface of a polyacrylonitrile supporting membrane and adsorbed for 5 min, and excess solution was removed. Then the organic phase mixture was placed on the surface of the membrane, and reaction was kept for 10 min. Excess solution was removed, and unreacted monomers were rinsed off with n-hexane. Then the membrane was dried in a blast air oven at 80° C. for 10 min, and the prepared lithium-magnesium separation membrane was stored in deionized water for further testing of the separation property.

The lithium-magnesium separation membrane was tested to have a retention rate of ~20% for Li⁺, a retention rate of ~89% for Mg²⁺, a lithium-magnesium selectivity of ~8, and a water permeation flux of ~14 L • m⁻² • h⁻¹ • bar⁻¹.

### Comparative Example

This comparative example is the same as example 1 except that the aqueous phase mixture of this comparative example did not contain 15-crown-5-ether.

The lithium-magnesium separation membrane was tested to have a retention rate of ~40% for Li⁺, a retention rate of ~75% for Mg²⁺, a lithium-magnesium selectivity of ~5, and a water permeation flux of ~4 L • m⁻² • h⁻¹ • bar⁻¹.

Comparing the test results of example 1 with those of the comparative example, it can be seen that the retention rates for Li⁺ and Mg²⁺ in example 1 were quite different, the lithium-magnesium selectivity in example 1 was higher, and the water permeation flux in example 1 was much larger than that in the comparative example. This indicated that no crown ether molecules were added in the process of reaction between the organic monomer and aqueous monomer in the comparative example, the organic monomer and aqueous monomer directly underwent a polymerization reaction, and a polyamide active layer taking the crown ether molecules as lithium-ion channels was not formed. Therefore, it was difficult to obtain a separation membrane with a high water permeation flux and a high lithium-magnesium selectivity.

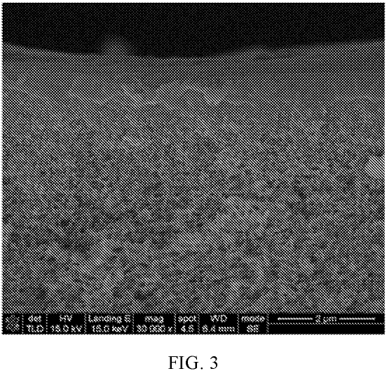

The lithium-magnesium separation membrane obtained in example 1 was tested for long-term stability. After 12 hours of continuous separation test, the water permeation flux and lithium-magnesium selectivity of the membrane were basically unchanged, indicating that the prepared lithium-magnesium separation membrane had a good long-term stability. The high-selectivity lithium-magnesium separation membrane obtained in example 1 was characterized by a scanning electron microscopy. The surface morphology and cross-sectional morphology of the obtained membrane are shown in FIGS. 2 and 3. The high-selectivity lithium-magnesium separation membrane was analyzed to have a smooth and dense surface with no defects, and the thickness of the selective separation layer was about 100 nm.

Therefore, the method for preparing a high-selectivity lithium-magnesium separation membrane in the above structure is adopted in the present invention. The method is simple in preparation process, mild in preparation conditions, wide in application range, easy to scale up, and easy to realize industrial production. The prepared high-selectivity lithium-magnesium separation membrane is high in firmness of the separation layer, large in permeation flux, and good in long-term operation stability.

Finally, it should be noted that the examples described above are intended only to illustrate, rather than to limit, the technical solution of the present invention. Although the present invention is described in detail with reference to the preferred embodiments, it should be understood by those of ordinary skill in the art that modifications or equivalent replacements may be made to the technical solution of the present invention, and these modifications or equivalent replacements cannot make the modified technical solution depart from the spirit and scope of the technical solution of the present invention.

1. A method for preparing a high-selectivity lithium-magnesium separation membrane, comprising the following steps:
(1) preparing an aqueous phase mixture containing an aqueous phase monomer, crown ethers or aza-macrocycles, an acid acceptor, a surfactant, and water;
(2) preparing an organic phase mixture containing an organic phase monomer and an organic solvent, wherein the organic solvent is incompatible with the water;
(3) contacting a supporting membrane with the aqueous phase mixture to adsorb for a preset time to obtain an aqueous phase monomer-adsorbed supporting membrane;
(4) contacting the aqueous phase monomer-adsorbed supporting membrane with the organic phase mixture for an interfacial polymerization reaction to obtain a nascent membrane;
(5) placing the nascent membrane obtained in the step (4) into a drying oven and heat-treating the nascent membrane to obtain the high-selectivity lithium-magnesium separation membrane;
wherein the aqueous phase mixture in the step (1) comprises, by mass fraction, 0.1-1% of the aqueous phase monomer, 0.1-1% of the crown ethers or the aza-macrocycles, 0.1-2% of the acid acceptor, 0.1-2% of the surfactant, and a remaining amount of the water; the organic phase mixture in the step (2) comprises, by mass fraction, 0.05-2% of the organic phase monomer and a remaining amount of the organic solvent; the high-selectivity lithium-magnesium separation membrane comprises a structurally stable polyamide active layer taking the crown ethers or the aza-macrocycles as internal channels allowing a permeation of lithium-ion and water molecules.

2. The method for preparing the high-selectivity lithium-magnesium separation membrane according to claim 1, wherein the aqueous phase monomer in the step (1) is selected from molecules consisting of two or more primary amine groups and secondary amine groups, the organic phase monomer is selected from molecules consisting of two or more acyl chloride groups.

3. The method for preparing the high-selectivity lithium-magnesium separation membrane according to claim 2, wherein the aqueous phase monomer in the step (1) is selected from one or more of polyethylene imine, ethylene imine polymer, polyether amine, piperazine, and m-phenylenediamine.

4. The method for preparing the high-selectivity lithium-magnesium separation membrane according to claim 1, wherein the crown ethers in the step (1) are selected from one or more of 15-crown-5-ether, cyclohexane-15-crown-5, benzo-15-crown ether-5, 4′-acetylbenzo-15-crown-5-ether, 4′-aminobenzo-15-crown-5-ether, 4, 13-diazo-18-crown-6-ether, 18-crown ether-6, 1-aza-18-crown-6-ether, and 2-(hydroxymethyl)-18-crown-6-ether.

5. The method for preparing the high-selectivity lithium-magnesium separation membrane according to claim 1, wherein the aza-macrocycles in the step (1) are selected from one or more of 1,4,7,10-tetraazacyclododecane, 1,4,7-tri-boc-1,4,7,10-tetraazacyclododecane, 1,4,7,10,13,16-hexaazacyclooctadecane, 1,4,7,10-tetraazacyclotridecane, 1,5,9-triazacyclododecane, 1,4,8,12-tetraazacyclopentadecane, 1,4,8,11-tetraazacyclotetradecane, Tetraethyl 1,4,8,11-tetraazacyclotetradecane-1,4,8,11-tetraacetate, and 1,4,8,11-tetramethyl-1,4,8,11-tetraazacyclotetradecane.

6. The method for preparing the high-selectivity lithium-magnesium separation membrane according to claim 1, wherein the acid acceptor in the step (1) is one or more of sodium hydroxide, sodium carbonate, and sodium bicarbonate.

7. The method for preparing the high-selectivity lithium-magnesium separation membrane according to claim 1, wherein the surfactant in the step (1) is one or more of sodium dodecyl benzene sulfonate, sodium dodecyl sulfate, Tween 20, and cetyl trimethyl ammonium bromide.

8. The method for preparing the high-selectivity lithium-magnesium separation membrane according to claim 1, wherein the organic phase monomer in the step (2) is selected from one or more of 1, 3, 5-benzenetricarbonyl trichloride, 2,4-mesitylenedisulfonyl dichloride, 5-amino-2,4,6-triiodoisophthaloyl dichloride, 1,2-benzenedisulfonyl dichloride, 1,3-benzenedisulfonyl chloride, 2,6-pyridinedicarbonyl chloride, p-phthaloyl chloride, and 2,4-mesitylenedisulfonyl dichloride.

9. The method for preparing the high-selectivity lithium-magnesium separation membrane according to claim 1, wherein the organic solvent in the step (2) is at leaast one selected from N-hexane, n-heptane, and cyclohexane.

10. The method for preparing the high-selectivity lithium-magnesium separation membrane according to claim 1, wherein a membrane material of the supporting membrane in the step (3) is polysulfone, polyethersulfone, polypropylene, polyvinylidene fluoride, polyacrylonitrile, polyimide, or polytetrafluoroethylene with a molecular weight cut-off of 10 kDa-80 kDa.

11. The method for preparing the high-selectivity lithium-magnesium separation membrane according to claim 1, wherein in the step (3), a contacting operation between the supporting membrane and the aqueous phase mixture is wetting or dipping, a contacting time is 1-10 min, and a temperature of the aqueous phase mixture is 15-40° C.

12. The method for preparing the high-selectivity lithium-magnesium separation membrane according to claim 1, wherein in the step (4), a contacting operation is wetting or dipping, a contacting time is 1-10 min, and a temperature of the organic phase mixture is 15-40° C.

13. The method for preparing the high-selectivity lithium-magnesium separation membrane according to claim 1, wherein in the step (5), a temperature of the heat-treating is 60-100° C., and a time is 1-20 min.
